(19) United States
(12) Patent Application Publication
(10) Pub. No.: US 2015/0199628 A1
(43) Pub. Date: Jul. 16, 2015

(54) FRAMEWORK FOR CASCADING RISK MANAGEMENT

(71) Applicant: International Business Machines Corporation, Armonk, NY (US)

(72) Inventor: MICHAEL J. GRAHOVAC, Columbia, MO (US)

(73) Assignee: International Business Machines Corporation, Armonk, NY (US)

(21) Appl. No.: 14/152,201

(22) Filed: Jan. 10, 2014

(51) Int. Cl. G06Q 10/06

(52) U.S. Cl. CPC G06Q 10/0635

(57) ABSTRACT

A risk area definition is created, wherein the risk area definition comprises at least a subset of a set of risk properties. An asset type definition is created, wherein the asset type definition comprises at least a subset of a set of asset properties, wherein an asset according to the asset type definition comprises an known commodity contributing to a revenue of the business organization. The risk area definition is refined into a risk, wherein the risk is a part of a risk area according to the risk area definition and comprises a business risk in an operation of the business organization. A set of resources is identified in the business organization to resolve the risk. An opportunity is identified, wherein the opportunity results from a subset of the set of resources. The set of resources is applied to resolve the risk in the business organization.

### TECHNICAL FIELD

The present invention relates generally to a method, system, and computer program product for managing risks in business operations of an enterprise. More particularly, the present invention relates to a method, system, and computer program product for a framework for cascading risk management.

### BACKGROUND

Managing risks is an important part of a business operation. In business enterprises (enterprise), budgeting for risk management is related to threat-based funding requests. In other words, risk management funding is tied to resolving an indentified risk condition that poses an imminent threat to the business operations.

Enterprises prefer to fund those activities that produce income, increase revenue, have a known return on investment, or generate or increase assets of the enterprise. Risk management often does not qualify on any of these grounds in typical enterprises. Therefore, risk management is an activity that is presently not considered for funding other than in threat situations.

### SUMMARY

The illustrative embodiments provide a method, system, and computer program product for a framework for cascading risk management. An embodiment includes a method for risk management in a business organization. The embodiment creates, using a processor and a memory, a risk area definition, wherein the risk area definition comprises at least a subset of a set of risk properties. The embodiment creates an asset type definition, wherein the asset type definition comprises at least a subset of a set of asset properties, wherein an asset according to the asset type definition comprises an known commodity contributing to a revenue of the business organization. The embodiment refines the risk area definition into a risk, wherein the risk is a part of a risk area according to the risk area definition and comprises a business risk in an operation of the business organization. The embodiment identifies a set of resources in the business organization to resolve the risk. The embodiment identifies an opportunity, wherein the opportunity results from a subset of the set of resources. The embodiment applies the set of resources to resolve the risk in the business organization.

Another embodiment includes a computer program product for risk management in a business organization. The embodiment further includes one or more computer-readable tangible storage devices. The embodiment further includes program instructions, stored on at least one of the one or more storage devices, to create, using a processor and a memory, a risk area definition, wherein the risk area definition comprises at least a subset of a set of risk properties. The embodiment further includes program instructions, stored on at least one of the one or more storage devices, to create an asset type definition, wherein the asset type definition comprises at least a subset of a set of asset properties, wherein an asset according to the asset type definition comprises an known commodity contributing to a revenue of the business organization. The embodiment further includes program instructions, stored on at least one of the one or more storage devices, to refine the risk area definition into a risk, wherein the risk is a part of a risk area according to the risk area definition and comprises a business risk in an operation of the business organization. The embodiment further includes program instructions, stored on at least one of the one or more storage devices, to identify a set of resources in the business organization to resolve the risk. The embodiment further includes program instructions, stored on at least one of the one or more storage devices, to identify an opportunity, wherein the opportunity results from a subset of the set of resources. The embodiment further includes program instructions, stored on at least one of the one or more storage devices, to apply the set of resources to resolve the risk in the business organization.

Another embodiment includes a computer system for risk management in a business organization. The embodiment further includes one or more processors, one or more computer-readable memories and one or more computer-readable tangible storage devices. The embodiment further includes program instructions, stored on at least one of the one or more storage devices for execution by at least one of the one or more processors via at least one of the one or more memories, to create, using a processor and a memory, a risk area definition, wherein the risk area definition comprises at least a subset of a set of risk properties. The embodiment further includes program instructions, stored on at least one of the one or more storage devices for execution by at least one of the one or more processors via at least one of the one or more memories, to create an asset type definition, wherein the asset type definition comprises at least a subset of a set of asset properties, wherein an asset according to the asset type definition comprises an known commodity contributing to a revenue of the business organization. The embodiment further includes program instructions, stored on at least one of the one or more storage devices for execution by at least one of the one or more processors via at least one of the one or more memories, to refine the risk area definition into a risk, wherein the risk is a part of a risk area according to the risk area definition and comprises a business risk in an operation of the business organization. The embodiment further includes program instructions, stored on at least one of the one or more storage devices for execution by at least one of the one or more processors via at least one of the one or more memories, to identify a set of resources in the business organization to resolve the risk. The embodiment further includes program instructions, stored on at least one of the one or more storage devices for execution by at least one of the one or more processors via at least one of the one or more memories, to identify an opportunity, wherein the opportunity results from a subset of the set of resources. The embodiment further includes program instructions, stored on at least one of the one or more storage devices for execution by at least one of the one or more processors via at least one of the one or more memories, to apply the set of resources to resolve the risk in the business organization.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts a block diagram of a framework for cascading risk management in accordance with an illustrative embodiment;

FIG. 4 depicts a risk area capability node diagram for cascading risk management in accordance with an illustrative embodiment; and

FIG. 5 depicts a flowchart of an example process of cascading risk management in accordance with an illustrative embodiment.

### DETAILED DESCRIPTION

The illustrative embodiments recognize that risk management activities can result in direct and indirect asset creation, direct or indirect contribution to revenue, or a combination thereof. For example, the illustrative embodiments recognize that risk management operations can be conducted to detect new or previously unidentified resources existing in an enterprise. A resource can be an asset in its own right, making the risk management operation become an asset contributing operation in the enterprise.

Similarly, risk management operations can also result in identification of a new or previously unrecognized capability within the enterprise. Such capabilities can be utilized for increasing revenue, return on investment, and other traditional measures of improving the income side of the enterprise's financial equation.

The illustrative embodiments further recognize that under certain circumstances, risk management operations also result in loss prevention or loss reduction. A reduction in loss is also a contribution to the income side of the enterprise's financial equation.

The operations of an enterprise are often controlled, regulated, directed, or otherwise managed with the help of a variety of systems. For example, enterprise architecture includes systems for enterprise-wide governance of a wide range of management, strategic, and operational issues. Business architecture comprises systems to manage operations in one or more business function areas of the enterprise. Information systems architecture includes systems to manage data processing and information systems needs of the various business function areas. Technology architecture provides technological tools and support for the business operations, business function areas, and enterprise-wide governance in the enterprise. These architectures including their systems, other comparable architectures, and other similarly purposed systems in different architectures are collectively referred to herein as enterprise systems.

The illustrative embodiments recognize that presently, enterprise systems are configured to manage risk as a threat, as described above. Presently, enterprise systems are not configured to manage risks in a manner that the risk management operation can become asset or income contributing to the enterprise. A framework is needed to enable enterprise systems to perform risk management operations in a non-threat manner, such that the risk management operations can contribute assets, revenue, or both, of the enterprise.

The illustrative embodiments used to describe the invention generally address and solve the above-described problems and other problems related to risk management in an enterprise. The illustrative embodiments provide a method, system, and computer program product for a framework for cascading risk management.

An embodiment describes a framework for cascading risk management wherein the embodiment identifies a risk area (risk subject) in an enterprise. The risk area or risk subject is a non-specific abstract definition of a risk condition likely to exist or occur in a part of the enterprise. An embodiment identifies a risk area based on a set of properties identified to be associated with risk conditions in the enterprise. The risk area according to an embodiment can include risk condition pertaining to an operational risk, a financial risk, a strategic risk, or any other type of risk.

The embodiment further identifies an abstract definition of how an asset is defined within the enterprise. As with the risk area, the embodiment described an asset in a non-specific abstract definition according to a set of properties expected in an asset in the enterprise.

An embodiment cascades the risk areas, the asset definitions through one or more enterprise systems for further refinement. An enterprise system further specifies, refines, or defines a specific risk objects or a specific asset objects that fit within the risk area definition and asset definition and are controllable, reachable, usable, or otherwise visible from the enterprise system. The specific risk objects and asset objects are stored such that the set of properties that are used for constructing the abstract risk area definition and the abstract asset definition can be improved in future iterative cycles based on the properties of the corresponding specific objects.

In the process of creating such risk and asset objects, an enterprise system identifies a resource that is controllable, reachable, usable, or otherwise visible from the enterprise system. An asset can be a resource but not all resources can be assets. For example, an insurance policy accessible from an enterprise system can be a resource and an asset, but a specific contracted skill recorded in an enterprise system in a resource that is not necessarily an asset.

Furthermore, in the process of risk and asset objects identification, an enterprise system can also identify a capability or capacity. A capability is a tool, structure, facility, feature, operation, or a function that results from a combination of resources, and can be applied to a known or new risk area, known or new risk object, or a combination thereof.

According to an embodiment, resources identified by an enterprise system are directly usable to resolve a risk in a risk area. Resolving a risk is the removal, elimination, mitigation, or reduction of the risk. Combinations of resources are also usable to form new capabilities or modify existing capabilities. The new, modified, or existing capabilities are usable to resolve a risk in a risk area.

Another embodiment identifies new risk areas based on the capabilities and resources identified by the one or more enterprise systems. Operating in this manner, an embodiment cascades from a framework to enterprise systems risk area and asset definitions, and receives from the enterprise systems into the framework risk objects, asset objects, resource (resource objects), and capabilities (capabilities objects). The received objects in turn enable improved definitions of risks and assets, resulting in the identification of new risk areas and assets in the enterprise. Thus, an embodiment allows risk management and risk management-related funding to evolve above a threat-like treatment and into an asset generating and/or revenue producing operation.

The illustrative embodiments are described with respect to, certain systems, inputs, structures, data processing systems, environments, components, and applications only as examples. Any specific manifestations of such artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

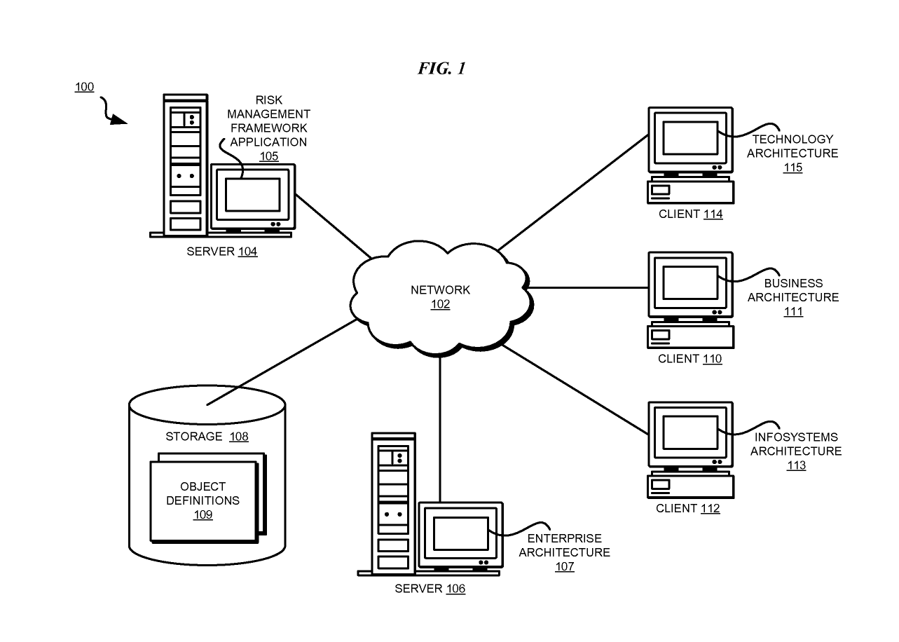

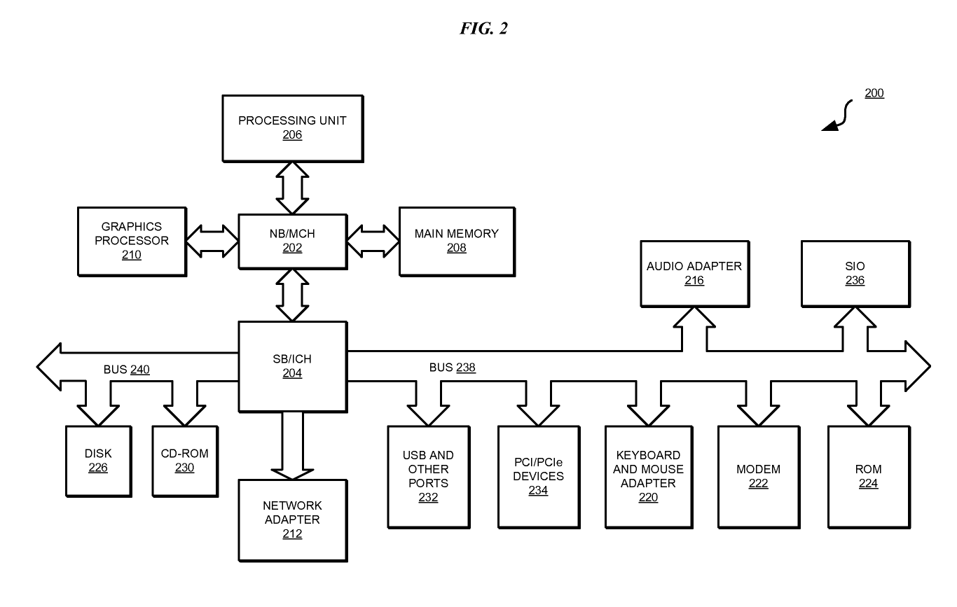

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables. Server 104 and server 106 couple to network 102 along with storage unit 108. Software applications may execute on any computer in data processing environment 100.

In addition, clients 110, 112, and 114 couple to network 102. A data processing system, such as server 104 or 106, or client 110, 112, or 114 may contain data and may have software applications or software tools executing thereon.

Only as an example, and without implying any limitation to such architecture, FIG. 1 depicts certain components that are usable in an example implementation of an embodiment. Servers 104 and 106, and clients 110, 112, 114, are depicted as servers and clients only as example. Data processing systems 104, 106, 110, 112, and 114 also represent example nodes in a cluster, partitions, and other configurations suitable for implementing an embodiment. For example, server 104 includes risk management framework application 105, which implements an embodiment described herein. Object definitions 109 in storage 108 are example definitions of computer-usable objects describing risk areas, risks, assets, resources, opportunities, capabilities, or instances thereof. Enterprise architecture 107, as modified to operate in conjunction with application 105, is one example part of an enterprise system as described herein. Business architecture 111, infosystems architecture 113, technology architecture 115, each as modified to operate in conjunction with application 105, are other example parts of the enterprise system. Other systems and architecture components of an enterprise system can similarly execute on one or more data processing systems in data processing environment 100.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

With reference to FIG. 2, this figure depicts a block diagram of a data processing system in which illustrative embodiments may be implemented. Data processing system 200 is an example of a computer, such as server 104 or client 110 in FIG. 1, or another type of device in which computer usable program code or instructions implementing the processes may be located for the illustrative embodiments.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) or solid-state drive (SSD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive or solid state drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system such as AIX® (AIX is a trademark of International Business Machines Corporation in the United States and other countries), Microsoft® Windows® (Microsoft and Windows are trademarks of Microsoft Corporation in the United States and other countries), or Linux® (Linux is a trademark of Linus Torvalds in the United States and other countries). An object oriented programming system, such as the Java™ programming system, may run in conjunction with the operating system and provides calls to the operating system from Java™ programs or applications executing on data processing system 200 (Java and all Java-based trademarks and logos are trademarks or registered trademarks of Oracle Corporation and/or its affiliates).

Instructions for the operating system, the object-oriented programming system, and applications or programs, such as risk management framework application 105, enterprise architecture 107, business architecture 111, infosystems architecture 113, and technology architecture 115 in FIG. 1, are located on storage devices, such as hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a PDA.

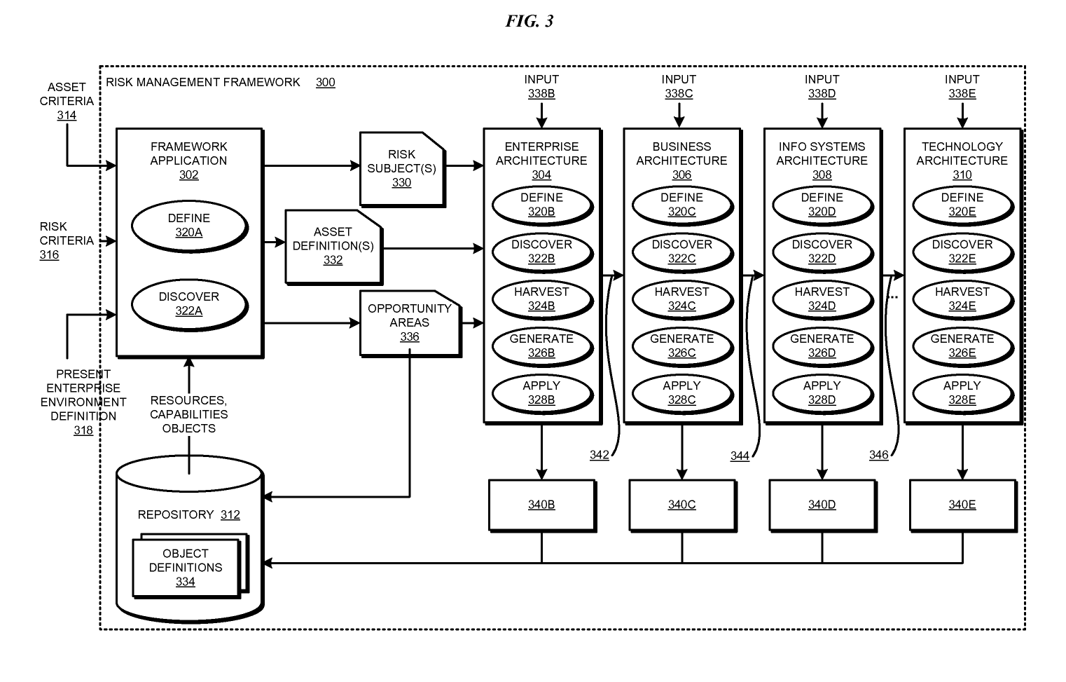

With reference to FIG. 3, this figure depicts a block diagram of a framework for cascading risk management in accordance with an illustrative embodiment. Risk management framework 300 includes application 302, which is an example of risk management framework application 105 in FIG. 1.

Enterprise architecture 304 is an example of enterprise architecture 107, business architecture 306 is an example of business architecture 111, infosystems architecture 308 is an example of infosystems architecture 113, and technology architecture 310 is an example of technology architecture 115 in FIG. 1. Repository 312 is an example of storage 108 in FIG. 1.

Application 302 receives one or more criteria 314 for defining an asset within an enterprise. In one embodiment, criteria 314 describe a set of properties, at least a subset of which must be included in anything that is to be defined as an asset in the enterprise.

Similarly, application 302 receives one or more criteria 316 for defining a risk within an enterprise. In one embodiment, criteria 316 describe a set of properties, at least a subset of which must be included in anything that is to be defined as a risk in the enterprise.

Application 302 further receives or determines definition 318, which defines a present state of the enterprise environment within which the risk management operations have to be managed. In one example embodiment, definition 318 lists those business or functional areas that are to participate (or not participate) in the risk management operation. In another example embodiment, definition 318 lists those enterprise systems that are to participate (or not participate) in the risk management operation.

“Define” operation defines a new object, or refines a broader object into a narrower object, based on the information for a given object type available to the system where the “define” operation is performed. “Discover” operation is the discovery of candidates for constructing an object of a certain type based on the activities, things, skills, functions, or data that are controllable, reachable, usable, or otherwise visible from the system where the “discover” operation is performed.

“Harvest” operation is an operation whereby a system extracts or encapsulates information about an activity, a thing, a skill, a function, or data into an object of a given type. “Generate” operation creates the object using the extracted or encapsulated information. “Apply” operation applies a generated object or an available object to a risk condition that is resolvable from the system where the “apply” operation is executing.

Depending on where a particular operation executes in framework 300, e.g., depending on a specific system in the given enterprise system, the operation can take different forms in implementation to provide similar functionality. For example, the “define” operation executes as operation 320A in application 302, operation 320B in enterprise architecture 304, operation 320C in business architecture 306, operation 320D in infosystems architecture 308, and operation 320E in technology architecture 310. Similarly, the “discover” operation executes as operation 322A in application 302, operation 322B in enterprise architecture 304, operation 322C in business architecture 306, operation 322D in infosystems architecture 308, and operation 322E in technology architecture 310.

A particular operation is deployed or used in a particular system in framework 300 depending on the specific implementation or circumstances. Not all operations need to execute in all systems or component of framework 300. An operation is deployable, usable, or executable in a particular system on demand.

For example, the “harvest” operation does not execute in application 302, but executes as operation 324B in enterprise architecture 304, operation 324C in business architecture 306, operation 324D in infosystems architecture 308, and operation 324E in technology architecture 310. Similarly, the “generate” operation is not shown in application 302, but executes as operation 326B in enterprise architecture 304, operation 326C in business architecture 306, operation 326D in infosystems architecture 308, and operation 326E in technology architecture 310. Likewise, the “apply” operation is not shown in application 302, but executes as operation 328B in enterprise architecture 304, operation 328C in business architecture 306, operation 328D in infosystems architecture 308, and operation 328E in technology architecture 310.

The various operations are depicted as present or absent in the various systems in FIG. 3 only as examples. The configuration of a specific enterprise system in framework 300 is modifiable to include or exclude an operation according to a particular implementation and the same is contemplated within the scope of the illustrative embodiments.

Operating in the manner of an embodiment described earlier, application 302 defines one or more risk subject objects 330 based on risk criteria 316 and definition 318 of the enterprise environment. Similarly, application 302 defines one or more asset definition objects 332 based on asset criteria 316 and definition 318 of the enterprise environment. Resource objects and capabilities objects may be available in the form of object definitions 334 in repository 312, e.g., from previous risk management operations in the enterprise. The defining of risk subject objects 330, asset definition objects 332, or both, may further utilize such resource objects and/or capabilities objects from repository 312.

In one embodiment, application 302 further discovers one or more opportunity areas, such as from object definitions 334 in repository 312. Any discovered opportunity area is formed into opportunity area object 336, and stored in repository 312. In a future risk management operation, application 302 may also consider any available opportunity area objects from repository 312 (not shown), to define risk subjects 330 and asset definitions 332.

An enterprise system receives risk subject 330, asset definition 332, or a refined manifestation thereof. The enterprise system also receives additional inputs, such as from other systems that are controllable, reachable, usable, or otherwise visible from the enterprise system. Addition inputs to an enterprise system may also include a human input, such as from an analyst responsible for operating the particular enterprise system.

Based on the inputs, and risk subject 330, asset definition 332, or a refined manifestation thereof, an enterprise system performs at least two functions. The enterprise system attempts to define or refine a risk, an asset, or both, and attempts to generate (throw, throw off) a resource object or a capability object. When applicable, the enterprise system also attempts a third function—applying a generated or available resource and/or a capability to a risk condition that is within the purview of the enterprise system.

Operating in this manner, in an example configuration of enterprise systems, enterprise architecture 304 receives risk subject(s) 330 and asset definition(s) 332 from application 302. Enterprise architecture 304 optionally receives input 338B from a data processing system, a user, an environment, or a combination thereof. Enterprise architecture 304 optionally outputs one or more objects 340B. When present, object(s) 340B may be resource objects, capability objects, or a combination thereof. Object(s) 340B are saved in repository 312.

Enterprise architecture 304 further produces output 342, using a combination of operations 320B, 322B, 324B, 326B, and 328B. Output 342 includes refined (more definite) forms of risk subjects 330, asset definitions 332, or a combination thereof. Enterprise architecture 304 optionally sends output 342 to another enterprise system.

Similarly, business architecture 306 receives from enterprise architecture 304, one or more risk subject(s) and/or asset definition(s) in the form of output 342. Business architecture 306 optionally receives input 338C from a data processing system, a user, an environment, or a combination thereof. Business architecture 306 optionally outputs one or more objects 340C. When present, object(s) 340C may be resource objects, capability objects, or a combination thereof. Object(s) 340C are saved in repository 312.

Business architecture 306 further produces output 344, using a combination of operations 320C, 322C, 324C, 326C, and 328C. Output 344 includes refined (more definite) forms of risk subjects, asset definitions, or a combination thereof. Business architecture 306 optionally sends output 344 to another enterprise system.

Similarly, infosystems architecture 308 receives from business architecture 306, one or more risk subject(s) and/or asset definition(s) in the form of output 344. Infosystems architecture 308 optionally receives input 338D from a data processing system, a user, an environment, or a combination thereof. Infosystems architecture 308 optionally outputs one or more objects 340D. When present, object(s) 340D may be resource objects, capability objects, or a combination thereof. Object(s) 340D are saved in repository 312.

Infosystems architecture 308 further produces output 346, using a combination of operations 320D, 322D, 324D, 326D, and 328D. Output 346 includes refined (more definite) forms of risk subjects, asset definitions, or a combination thereof. Infosystems architecture 308 optionally sends output 346 to another enterprise system.

Any number of enterprise systems can be arranged in any order in a similar manner, to receive progressively refined risk subjects and asset definitions from other enterprise systems. In the depicted example configuration, technology architecture 310 receives from infosystems architecture 308, one or more risk subject(s) and/or asset definition(s) in the form of output 346. Technology architecture 310 optionally receives input 338E from a data processing system, a user, an environment, or a combination thereof. Technology architecture 310 optionally outputs one or more objects 340E. When present, object(s) 340E may be resource objects, capability objects, or a combination thereof. Object(s) 340E are saved in repository 312.

When another enterprise system is configured to receive outputs from technology architecture 310, technology architecture 310 can further produce an output in the manner of output 346, using a combination of operations 320E, 322E, 324E, 326E, and 328E, and send such output to another enterprise system.

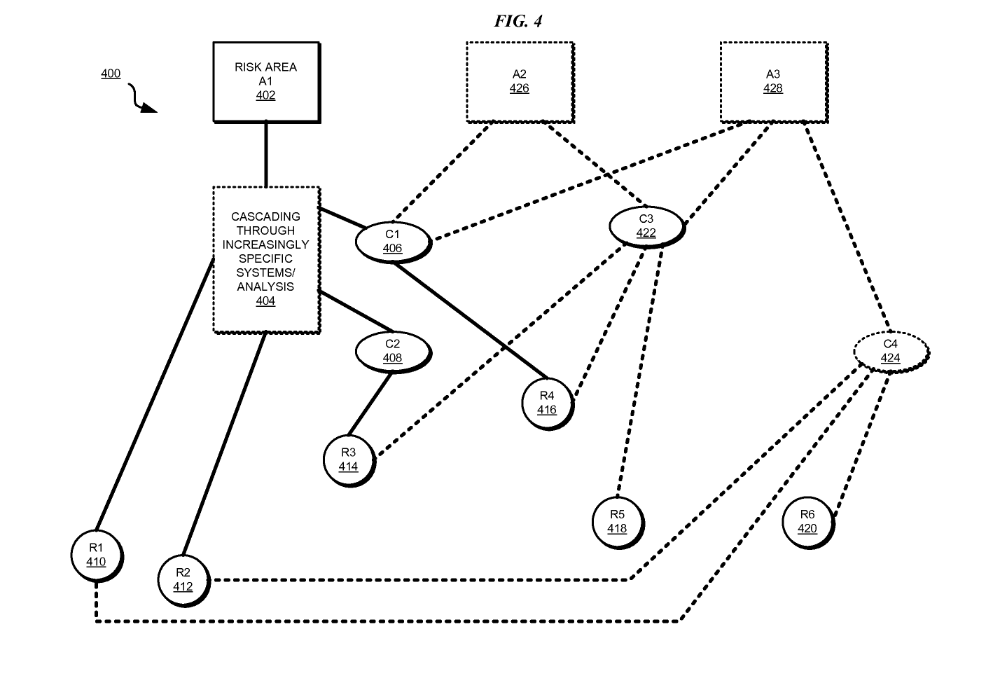

With reference to FIG. 4, this figure depicts a risk area capability node diagram for cascading risk management in accordance with an illustrative embodiment. Diagram 400 is a product of the operation of framework 300 in FIG. 3.

Risk area 402 (labeled “A1”) is an example of risk subject 330 in FIG. 3. Assume that risk area A1 is defined by application 302 and cascaded down through one or more enterprise systems 404, or one or more analytical processes embodied therein. Enterprise systems 404 refine, with increasing specificity, risks in risk area A1. In the manner of the example operation of framework 300 in FIG. 3, enterprise systems 404 generate capability object 406 (labeled “C1”), capability object 408 (labeled “C2”), resource object 410 (labeled “R1”), and resource object 412 (labeled “R2”). New resource 414 (labeled “R3”) is represented as being related to capability C2. Objects C1, C2, R1, R2, and R3 are made available in the framework, such as by depositing or storing those objects in repository 312.

Further assume that resource objects 416, 418, and 420 (labeled “R4”, “R5”, and “R6”, respectively) represent resources that have previously been identified in the enterprise environment. Similarly, assume that capability object 422 (labeled “C3”) has been previously identified in the enterprise environment.

Operating in the manner of example framework 300, an application, such as application 302, discovers that existing capability C3, which is based on known resources R4 and R5, can be enhanced or otherwise modified based on new resource R3. The application further discovers that a new capability, represented by capability object 424 (labeled “C4”) is now possible in the enterprise environment because of the availability of new resources R1 and R2, in combination with existing resource R6.

The application further discovers that based on new capability C1 and enhanced capability C3, a new type of risk area, risk area 426 (labeled “A2”), can be defined and addressed in the enterprise via risk management operations. Similarly, the application further discovers that based on new capability C1, enhanced capability C3, new capability C2, and new capability C4, a new type of risk area, risk area 428 (labeled “A3”), can be defined and addressed in the enterprise via risk management operations.

Risk areas A2 and A3 can then be cascaded down through one or more enterprise systems 404 or associated analytical processes for resolving risk areas A2 and A3. Additionally, as a result of such cascading, new resource identification, new capabilities identification, new risk areas identification, or a combination thereof, become possible in the enterprise environment, as described with respect to the cascading of risk area A1.

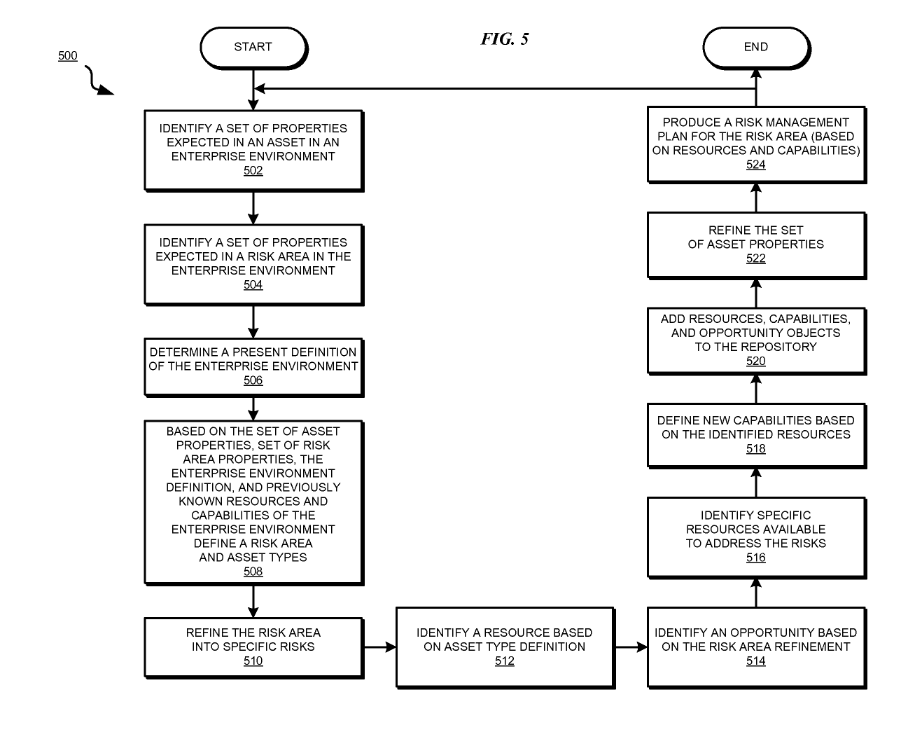

With reference to FIG. 5, this figure depicts a flowchart of an example process of cascading risk management in accordance with an illustrative embodiment. Process 500 can be implemented in framework 300 in FIG. 3, with all or some components of process 500 being implemented in application 302.

An application, for example, application 302 in FIG. 3, receives or otherwise identifies a set of properties, at least a subset of which is expected in an asset in a given enterprise environment (block 502). The application also receives or otherwise identifies a set of properties, at least a subset of which is expected in a risk area in the enterprise environment (block 504). The application also receives or determines a present definition of the given enterprise environment (block 506).

Based on the set of asset properties, the ser of risk area properties, the enterprise environment definition, and any previously known resources and capabilities in the enterprise environment, the application creates a definition of a risk area, a definition of an asset type, or a combination thereof (block 508). Any number of risk area definitions and asset type definitions can be created in a similar manner in block 508.

The application, operating in conjunction with one or more enterprise systems, refines the risk area into one or more specific risks (block 510). The application, operating in conjunction with one or more enterprise systems, optionally identifies a (previously unidentified) resource based on the asset type definition (block 512).

The application, operating in conjunction with one or more enterprise systems, optionally identifies an opportunity based on the risk area refinement (block 514). Any number of opportunities may be identified in block 514. Furthermore, as a part of identifying an opportunity in block 514, the application also encapsulates the opportunity information into an object form that is capable of storage in a repository, e.g., repository 312 in FIG. 3.

The application, operating in conjunction with one or more enterprise systems, identifies specific resources, previously known or identified in block 511, to address a specific risk (block 516). The application, operating in conjunction with one or more enterprise systems, optionally, also identifies one or more previously unidentified capabilities made possible by the identified resources (block 518).

A resource is an asset. A newly identified resource is a new asset. Similarly, a capability can be an asset. A newly identified capability can be a new asset.

An opportunity can also be regarded as an asset. For example, an newly identified opportunity may allow the enterprise to engage in a new business activity, reduce the risk of a new or existing business activity, reduce cost, increase output or output variety, and so on. Accordingly, the objects corresponding to the resources, the capabilities, and the opportunities are added, such as in the form of asset objects in repository 312, for future risk management operations (block 520). The application refines one or more asset type to account for the newly added assets (block 522).

The application produces a risk management plan for the risk area based on the identified resources and capabilities (block 524). The application ends process 500 thereafter. In one embodiment, the application identifies new risk areas (not shown) based on the identified resources, capabilities, or a combination thereof, and returns to block 502 for another iteration of process 500.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Thus, a computer implemented method, system, and computer program product are provided in the illustrative embodiments for a framework for cascading risk management. While the various embodiment are described using risk area and risk subject as interchangeable terminology, an implementation may modify an embodiment to reflect a configuration where a risk area includes one or more risk subjects, or vice-versa. The operation of an embodiment remains substantially as described herein with such alternate configurations and such alternate configurations are contemplated within the scope of the illustrative embodiments.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable storage device(s) or computer readable media having computer readable program code embodied thereon.

Any combination of one or more computer readable storage device(s) or computer readable media may be utilized. The computer readable medium may be a computer readable storage medium. A computer readable storage device may be, for example, but not limited to, an electronic, magnetic, optical, electromagnetic, or semiconductor system, apparatus, or device, or any suitable combination of the foregoing. More specific examples (a non-exhaustive list) of the computer readable storage device would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage device may be any tangible device or medium that can store a program for use by or in connection with an instruction execution system, apparatus, or device. The term “computer readable storage device,” or variations thereof, does not encompass a signal propagation media such as a copper cable, optical fiber or wireless transmission media.

Program code embodied on a computer readable storage device or computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to one or more processors of one or more general purpose computers, special purpose computers, or other programmable data processing apparatuses to produce a machine, such that the instructions, which execute via the one or more processors of the computers or other programmable data processing apparatuses, create means for implementing the functions/acts specified in the flowchart and/or block diagram block or blocks.

These computer program instructions may also be stored in one or more computer readable storage devices or computer readable media that can direct one or more computers, one or more other programmable data processing apparatuses, or one or more other devices to function in a particular manner, such that the instructions stored in the one or more computer readable storage devices or computer readable medium produce an article of manufacture including instructions which implement the function/act specified in the flowchart and/or block diagram block or blocks.

The computer program instructions may also be loaded onto one or more computers, one or more other programmable data processing apparatuses, or one or more other devices to cause a series of operational steps to be performed on the one or more computers, one or more other programmable data processing apparatuses, or one or more other devices to produce a computer implemented process such that the instructions which execute on the one or more computers, one or more other programmable data processing apparatuses, or one or more other devices provide processes for implementing the functions/acts specified in the flowchart and/or block diagram block or blocks.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. A method for risk management in a business organization, the method comprising:
creating, using a processor and a memory, a risk area definition, wherein the risk area definition comprises at least a subset of a set of risk properties;
creating an asset type definition, wherein the asset type definition comprises at least a subset of a set of asset properties, wherein an asset according to the asset type definition comprises an known commodity contributing to a revenue of the business organization;
refining the risk area definition into a risk, wherein the risk is a part of a risk area according to the risk area definition and comprises a business risk in an operation of the business organization;
identifying a set of resources in the business organization to resolve the risk;
identifying an opportunity, wherein the opportunity results from a subset of the set of resources; and
applying the set of resources to resolve the risk in the business organization.

2. The method of claim 1, wherein the opportunity comprises a previously unidentified revenue opportunity for the business organization, further comprising:
recognizing the opportunity as a new asset in the business organization, wherein the opportunity additionally contributes to the revenue of the business organization.

3. The method of claim 2, further comprising:
modifying the set of asset properties to include a property of the new asset, forming a modified set of asset properties; and
using the modified set of asset properties to create a modified asset type definition.

4. The method of claim 3, further comprising:
increasing a collection of assets of the business organization by identifying a new opportunity using the modified asset type definition.

5. The method of claim 1, wherein the set of resources comprises a new resource, wherein the new resource is not known in the business organization.

6. The method of claim 5, further comprising:
recognizing the new resource as a new asset, wherein the new resource additionally contributes to the revenue of the business organization.

7. The method of claim 6, further comprising:
modifying the set of asset properties to include a property of the new asset, forming a modified set of asset properties; and
using the modified set of asset properties to create a modified asset type definition.

8. The method of claim 7, further comprising:
increasing a collection of assets of the business organization by identifying a second new resource using the modified asset type definition.

9. The method of claim 1, wherein the risk area definition is an abstract definition, and wherein the refining assigns a specific value to a risk property in the subset of the set of risk properties.

10. The method of claim 1, wherein the method is embodied in a computer program product comprising one or more computer-readable tangible storage devices and computer-readable program instructions which are stored on the one or more computer-readable tangible storage devices and executed by one or more processors.

11. The method of claim 1, wherein the method is embodied in a computer system comprising one or more processors, one or more computer-readable memories, one or more computer-readable tangible storage devices and program instructions which are stored on the one or more computer-readable tangible storage devices for execution by the one or more processors via the one or more memories and executed by the one or more processors.

12. A computer program product for risk management in a business organization, the computer program product comprising:
one or more computer-readable tangible storage devices;
program instructions, stored on at least one of the one or more storage devices, to create, using a processor and a memory, a risk area definition, wherein the risk area definition comprises at least a subset of a set of risk properties;
program instructions, stored on at least one of the one or more storage devices, to create an asset type definition, wherein the asset type definition comprises at least a subset of a set of asset properties, wherein an asset according to the asset type definition comprises an known commodity contributing to a revenue of the business organization;
program instructions, stored on at least one of the one or more storage devices, to refine the risk area definition into a risk, wherein the risk is a part of a risk area according to the risk area definition and comprises a business risk in an operation of the business organization;
program instructions, stored on at least one of the one or more storage devices, to identify a set of resources in the business organization to resolve the risk;
program instructions, stored on at least one of the one or more storage devices, to identify an opportunity, wherein the opportunity results from a subset of the set of resources; and
program instructions, stored on at least one of the one or more storage devices, to apply the set of resources to resolve the risk in the business organization.

13. The computer program product of claim 12, wherein the opportunity comprises a previously unidentified revenue opportunity for the business organization, further comprising:
program instructions, stored on at least one of the one or more storage devices, to recognize the opportunity as a new asset in the business organization, wherein the opportunity additionally contributes to the revenue of the business organization.

14. The computer program product of claim 13, further comprising:
program instructions, stored on at least one of the one or more storage devices, to modify the set of asset properties to include a property of the new asset, forming a modified set of asset properties; and
using the modified set of asset properties to create a modified asset type definition.

15. The computer program product of claim 14, further comprising:
program instructions, stored on at least one of the one or more storage devices, to increase a collection of assets of the business organization by identifying a new opportunity using the modified asset type definition.

16. The computer program product of claim 12, wherein the set of resources comprises a new resource, wherein the new resource is not known in the business organization.

17. The computer program product of claim 16, further comprising:
program instructions, stored on at least one of the one or more storage devices, to recognize the new resource as a new asset, wherein the new resource additionally contributes to the revenue of the business organization.

18. The computer program product of claim 17, further comprising:
program instructions, stored on at least one of the one or more storage devices, to modify the set of asset properties to include a property of the new asset, forming a modified set of asset properties; and
program instructions, stored on at least one of the one or more storage devices, to use the modified set of asset properties to create a modified asset type definition.

19. The computer program product of claim 18, further comprising:
program instructions, stored on at least one of the one or more storage devices, to increase a collection of assets of the business organization by identifying a second new resource using the modified asset type definition.

20. A computer system for risk management in a business organization, the computer system comprising:
one or more processors, one or more computer-readable memories and one or more computer-readable tangible storage devices;
program instructions, stored on at least one of the one or more storage devices for execution by at least one of the one or more processors via at least one of the one or more memories, to create, using a processor and a memory, a risk area definition, wherein the risk area definition comprises at least a subset of a set of risk properties;
program instructions, stored on at least one of the one or more storage devices for execution by at least one of the one or more processors via at least one of the one or more memories, to create an asset type definition, wherein the asset type definition comprises at least a subset of a set of asset properties, wherein an asset according to the asset type definition comprises an known commodity contributing to a revenue of the business organization;
program instructions, stored on at least one of the one or more storage devices for execution by at least one of the one or more processors via at least one of the one or more memories, to refine the risk area definition into a risk, wherein the risk is a part of a risk area according to the risk area definition and comprises a business risk in an operation of the business organization;
program instructions, stored on at least one of the one or more storage devices for execution by at least one of the one or more processors via at least one of the one or more memories, to identify a set of resources in the business organization to resolve the risk;
program instructions, stored on at least one of the one or more storage devices for execution by at least one of the one or more processors via at least one of the one or more memories, to identify an opportunity, wherein the opportunity results from a subset of the set of resources; and
program instructions, stored on at least one of the one or more storage devices for execution by at least one of the one or more processors via at least one of the one or more memories, to apply the set of resources to resolve the risk in the business organization.
